(19) United States
(12) Patent Application Publication
(10) Pub. No.: US 2025/0321521 A1
(43) Pub. Date: Oct. 16, 2025

(54) HEATING DEVICE, FIXING DEVICE, AND IMAGE FORMING APPARATUS

(71) Applicants: Toshihiko SHIMOKAWA, Kanagawa (JP); Kentaro YAMANAKA, Kanagawa (JP); Ryohei MATSUDA, Kanagawa (JP); Ryohhei SUGIYAMA, Kanagawa (JP); Yoshiki YAMAGUCHI, Kanagawa (JP); Hiroshi YOSHINAGA, Kanagawa (JP)

(72) Inventors: Toshihiko SHIMOKAWA, Kanagawa (JP); Kentaro YAMANAKA, Kanagawa (JP); Ryohei MATSUDA, Kanagawa (JP); Ryohhei SUGIYAMA, Kanagawa (JP); Yoshiki YAMAGUCHI, Kanagawa (JP); Hiroshi YOSHINAGA, Kanagawa (JP)

(21) Appl. No.: 19/097,862

(22) Filed: Apr. 2, 2025

(30) Foreign Application Priority Data
Apr. 10, 2024 (JP) 2024-063307

(51) Int. Cl. G03G 15/20

(52) U.S. Cl. CPC G03G 15/2053; G03G 15/2064

(57) ABSTRACT

A heating device includes a first rotator; and a second rotator facing an outer surface of the first rotator. The first rotator includes a nip forming member in contact with an inner face of the first rotator to form a nip portion between the first rotator and the second rotator; a heating source to heat the first rotator; a reflector elongated in a longitudinal direction, the reflector to reflect heat generated by the heating source to the inner face of the first rotator; a support to receive a pressure from the second rotator via the nip forming member; and a base interposed between the support and the nip forming member. The reflector includes a reflecting section facing the heating source; and a heat transmission section between the base and the nip forming member.

### CROSS-REFERENCE TO RELATED APPLICATIONS

This patent application is based on and claims priority pursuant to 35 U.S.C. § 119 (a) to Japanese Patent Application No. 2024-063307, filed on Apr. 10, 2024, in the Japan Patent Office, the entire disclosure of which is hereby incorporated by reference herein.

### BACKGROUND

### Technical Field

The present disclosure relates to a heating device, a fixing device, and an image forming apparatus.

### Related Art

Fixing devices are an example of heating devices to be mounted in image forming apparatuses, such as copiers and printers. Such a fixing device heats a sheet to which an image has been transferred, thereby fixing this image onto the sheet.

A fixing device includes: a pair of rotators, such as a pair of rollers or belts; and a heating source that heats at least one of the rotators. When a sheet carrying an unfixed image enters (nip portion) between the rotators that have been heated to a predetermined temperature, this sheet is heated and pressurized between the rotators, so that the image is fixed onto the sheet.

The fixing device also includes a reflector in order for the heating source to heat the rotors more efficiently. This reflector reflects the heat radiated from the heating source to the rotators. The reflector is typically made of a material, such as aluminum, that effectively reflects the heat. However, the temperature of the reflector is prone to increase with time because the reflector absorbs part of the heat radiated from the heating source. The reflector is exposed to the heat of the heating source for a long time, especially when many sheets are continuously fixed. In this case, the temperature of the reflector may excessively increase. When the temperature of the reflector excessively increases, the surface of the reflector may be discolored. As a result, the reflection function thereof might be lowered.

### SUMMARY

The present disclosure provides a heating device includes a first rotator; and a second rotator facing an outer surface of the first rotator. The first rotator includes a nip forming member in contact with an inner face of the first rotator to form a nip portion between the first rotator and the second rotator; a heating source to heat the first rotator; a reflector elongated in a longitudinal direction, the reflector to reflect heat generated by the heating source to the inner face of the first rotator; a support to receive a pressure from the second rotator via the nip forming member; and a base interposed between the support and the nip forming member. The reflector includes a reflecting section facing the heating source; and a heat transmission section between the base and the nip forming member, and the heat transmission section includes a positioning section disposed at a vicinity of a center of the heat transmission section in the longitudinal direction, the positioning section positions the reflector with respect to the base, the positioning section having a first contacting area contacting with the nip forming member; and end sections closer to both ends of the heat transmission section than the positioning section in the longitudinal direction, each of the end sections having a second contacting area smaller than the first contacting area to contact with the nip forming member.

The present disclosure further provides a heating device including a first rotator; and a second rotator facing an outer surface of the first rotator, wherein the first rotator includes a nip forming member in contact with an inner face of the first rotator to form a nip portion, between the first rotator and the second rotator; a heating source to heat the first rotator; a reflector elongated in a longitudinal direction, the reflector to reflect heat generated by the heating source to the inner face of the first rotator; a support to receive a pressure from the second rotator via the nip forming member; and a base interposed between the support and the nip forming member, and the reflector includes a reflecting section facing the heating source; and a heat transmission section between the base and the nip forming member, and the heat transmission section includes: a positioning section disposed at a vicinity of a center of the sheet in a width direction of the sheet passing through the nip portion and facing the heat transmission section, the positioning section positions the reflector with respect to the base, the positioning section having a first contacting area contacting with the nip forming member; and end sections closer to both ends of the sheet in the width direction than the positioning section in the longitudinal direction, each of the end sections having a second contacting area smaller than the first contacting area to contact with the nip forming member.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIG. 1 is a configuration diagram of an image forming apparatus;

FIG. 2 is a schematic configuration diagram of a fixing device;

FIG. 3 is a perspective view of the fixing device;

FIG. 4 is a perspective view of a heating unit disposed inside a fixing belt of the fixing device;

FIG. 5 is a cross-sectional view of the heating unit cut at a position adjacent to an end thereof in a longitudinal direction;

FIG. 6 is a diagram illustrating a relationship between positions of holes at both ends of a reflector and the width of a sheet passing the reflector;

FIG. 7 is a cross-sectional view illustrating a modification;

FIG. 8 is a cross-sectional view of a heating unit cut at a central position in a longitudinal direction;

FIG. 9 is a perspective view of another modification;

FIG. 10 is a cross-sectional view of still another modification;

FIG. 11 is a perspective view of a heating unit;

FIG. 12 is a cross-sectional view of a heating unit;

FIG. 13 is a view of the heating unit as viewed from a downstream side in a sheet conveyance direction; and

FIG. 14 is a view of the heating unit as viewed from an upstream side in the sheet conveyance direction.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present disclosure will be described with reference to the accompanying drawings. Referring now to the drawings, wherein like reference numerals designate identical or corresponding parts throughout the several views thereof, an image forming apparatus according to an embodiment of the present disclosure is described below.

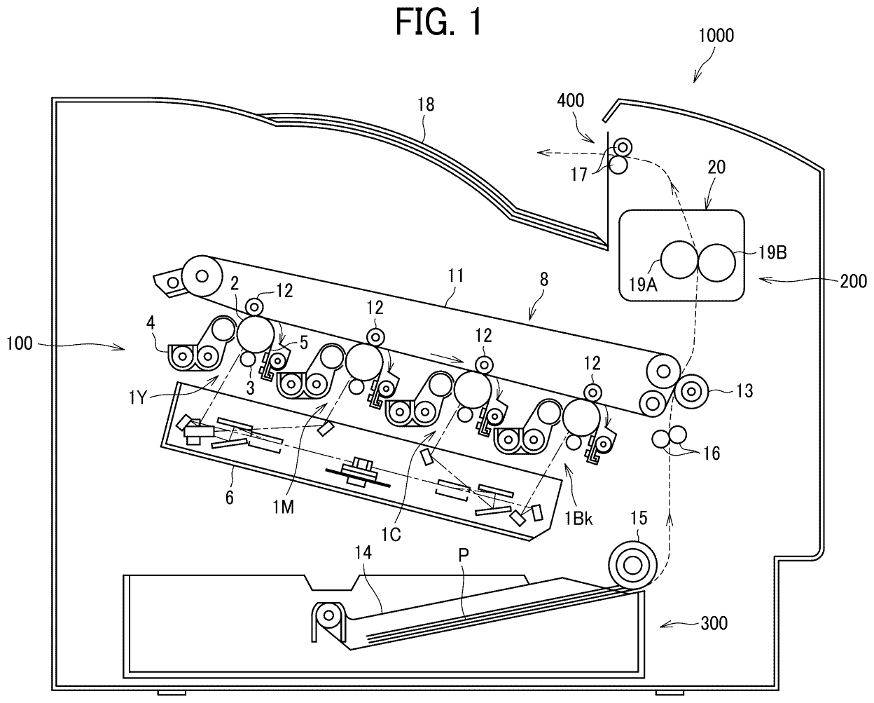

FIG. 1 is a schematic configuration diagram of an image forming apparatus 1000. In the following description, an “image forming apparatus” implies a printer, a copier, a facsimile machine, or a multifunction peripheral including at least two of printing, copying, scanning, or facsimile functions. The term “image formation” in the following description means not only forming an image having a meaning such as texts and graphics but also forming an image having no meaning such as patterns. Referring to FIG. 1, a description will be first given of an overall configuration and operation of the image forming apparatus.

### Overall Configuration of Image Forming Apparatus

As illustrated in FIG. 1, the image forming apparatus 1000 includes an image forming section 100, a fixing section 200, a sheet supply section 300, and a sheet ejection section 400.

### Image Forming Section

The image forming section 100 is a section that forms an image on a sheet to be used as a recording medium. The image forming section 100 includes four image forming units 1Y, 1M, 1C, and 1Bk, an exposure device 6, and a transfer device 8.

Each of the four image forming units 1Y, 1M, 1C, and 1Bk includes an electrostatic latent image bearer 2, a charging member 3, a developing device 4, and a cleaning member 5.

The electrostatic latent image bearer 2 is a rotator that carries an electrostatic latent image on a surface thereof. Examples of the electrostatic latent image bearer 2 include a photoreceptor drum and an endless photoreceptor belt.

The charging member 3 is a member that charges the surface of the electrostatic latent image bearer 2. The charging member 3 may be any member that can apply a voltage to the surface of the electrostatic latent image bearer 2 to uniformly charge this surface and can be selected as appropriate depending on the purpose. Specific examples of the charging member 3 include: a contact charging member, such as a conductive or semiconductive charging roller, a magnetic brush, a fur brush, a film, or a rubber blade; and a non-contact charging member using corona discharge.

The developing device 4 is a device that supplies toner as a developer to the surface of the electrostatic latent image bearer 2. The developing device 4 stores toners of different colors, such as yellow, magenta, cyan, and black corresponding to color separation components of color images for the respective image forming units 1Y, 1M, 1C, and 1Bk.

The cleaning member 5 is a member that removes residual toner and other foreign matter from the electrostatic latent image bearer 2. One example of the cleaning member 5 is a cleaning blade disposed so as to be in contact with the surface of the electrostatic latent image bearer 2.

The exposure device 6 is a device that exposes the charged surface of the electrostatic latent image bearer 2 to form an electrostatic latent image thereon. The exposure device 6 may be any device that can expose the charged surface of the electrostatic latent image bearer 2 and can be selected as appropriate depending on the purpose. The exposure device 6 may be one selected from various exposure devices, specific examples of which include a copying optical system, a rod lens array system, a laser optical system, a liquid crystal shutter optical system, and a light-emitting diode (LED) optical system.

The transfer device 8 is a device that transfers an image onto a sheet. The transfer device 8 includes an intermediate transfer belt 11, primary transfer rollers 12, and a secondary transfer roller 13. The intermediate transfer belt 11 is an endless belt stretched by multiple support rollers. Four primary transfer rollers 12 are provided inside the loop of the intermediate transfer belt 11. Each of the primary transfer rollers 12 is in contact with a corresponding electrostatic latent image bearer 2 via the intermediate transfer belt 11 to form a primary transfer nip between the intermediate transfer belt 11 and the electrostatic latent image bearer 2. The secondary transfer roller 13 is in contact with the outer surface of the intermediate transfer belt 11. As a result, the secondary transfer roller 13 and the intermediate transfer belt 11 form a secondary transfer nip therebetween.

### Fixing Section

The fixing section 200 includes a fixing device 20 that heats a sheet to fix an image onto the sheet. The fixing device 20 is an example of a heating device that heats a sheet. Specifically, the fixing device 20 includes: a pair of rotators 19A and 19B that are in contact with each other; and a heating source that heats at least one of the rotator 19A or 19B.

### Sheet Supply Section

The sheet supply section 300 includes: a sheet feeding cassette 14 that stores sheets P; and a sheet feeding roller 15 that feeds the sheets P from the sheet feeding cassette 14. Hereinafter, a “sheet”, which is a recording medium used for the image formation, will be described as a “paper sheet”; however, the “sheet” is not limited to a sheet of paper (paper sheet). Alternatively, the sheet may be an OHP sheet or fabric, a metal sheet, a plastic film, and a prepreg sheet in which carbon fibers are impregnated with a resin in advance. Examples of the paper sheet include a plain paper sheet, as well as a thick paper sheet, a postcard, an envelope, a thin paper sheet, a coated paper sheet (e.g., a coated paper or art paper sheet), and a tracing paper sheet.

### Sheet Ejection Section

The sheet ejection section 400 includes: a pair of sheet ejection rollers 17 that eject the sheet P; and a sheet ejection tray 18 on which the ejected sheet P is to be placed.

### Image Forming Operation

Next, an operation of the image forming apparatus 1000 will be described with reference to FIG. 1.

When the image forming apparatus 1000 starts an image forming operation in response to an instruction from an operation panel thereof or an external terminal, the image forming units 1Y, 1M, 1C, and 1Bk start to rotate the corresponding electrostatic latent image bearers 2. The charging members 3 then charge the surfaces of the corresponding electrostatic latent image bearers 2. As a result, the surface of each electrostatic latent image bearer 2 is charged to a uniform high potential. Based on image data of a document read by a document reading device or print image data instructed by the external terminal, the exposure device 6 then exposes the charged surface (charged surface) of each electrostatic latent image bearer 2. As a result, the electric potential of the exposed portion is lowered, so that an electrostatic latent image is formed on the surface of each electrostatic latent image bearer 2. Thereafter, the toners are supplied from the developing devices 4 to the corresponding electrostatic latent image bearers 2, so that toner images of different colors are formed on each electrostatic latent image bearer 2.

With the rotation of each electrostatic latent image bearer 2, the toner image on each electrostatic latent image bearer 2 reaches the primary transfer nip (the position of a corresponding primary transfer roller 12). At the primary transfer nip, toner images are then sequentially transferred so as to overlap each other from each electrostatic latent image bearer 2 onto the intermediate transfer belt 11 being rotationally driven. In this way, a full-color toner image is formed on the intermediate transfer belt 11. The application of this image formation is not limited to a case where a full-color image is used with all of the image forming units 1Y, 1M, 1C, and 1Bk. Alternatively, the application of the image formation may also be a case where a monochrome image is formed with one of the image forming unit 1Y, 1M, 1C, or 1Bk or a case where a two- or three-color image is formed with two or three of these image forming units. After the toner image has been transferred onto the intermediate transfer belt 11, each cleaning member 5 performs a cleaning operation on a corresponding electrostatic latent image bearer 2. As a result, foreign matter, such as residual toner, is removed from the surface of each electrostatic latent image bearer 2.

With the rotation of the intermediate transfer belt 11, the toner image that has been transferred onto the intermediate transfer belt 11 is conveyed to the secondary transfer nip (the position of the secondary transfer roller 13). The toner image on the intermediate transfer belt 11 is then transferred onto a sheet P being conveyed to the secondary transfer nip. At this time, the sheet P being conveyed to the secondary transfer nip corresponds to a sheet that has been supplied from the sheet supply section 300. After the start of the image forming operation, the sheet P is fed from the sheet feeding cassette 14 by the rotation of the sheet feeding roller 15. When the fed sheet P comes into contact with a timing roller pair 16 before reaching the secondary transfer nip, the conveying of the sheet P temporarily stops. Thereafter, the timing roller pair 16 rotates at a predetermined timing to convey the sheet P to the secondary transfer nip in time with the conveyance of the toner image on the intermediate transfer belt 11. As a result, the toner images on the intermediate transfer belt 11 are transferred onto the sheet P.

The sheet P to which the toner image has been transferred is conveyed to the fixing section 200. When passing between the pair of rotators 19A and 19B, the sheet P is heated and pressurized therebetween, so that the toner image on the sheet Pis fixed onto the sheet P. Thereafter, the sheet Pis conveyed to the sheet ejection section 400 and ejected by the sheet ejection rollers 17 to the sheet ejection tray 18. In this way, a series of image forming operations are completed.

### Basic Configuration of Fixing Device

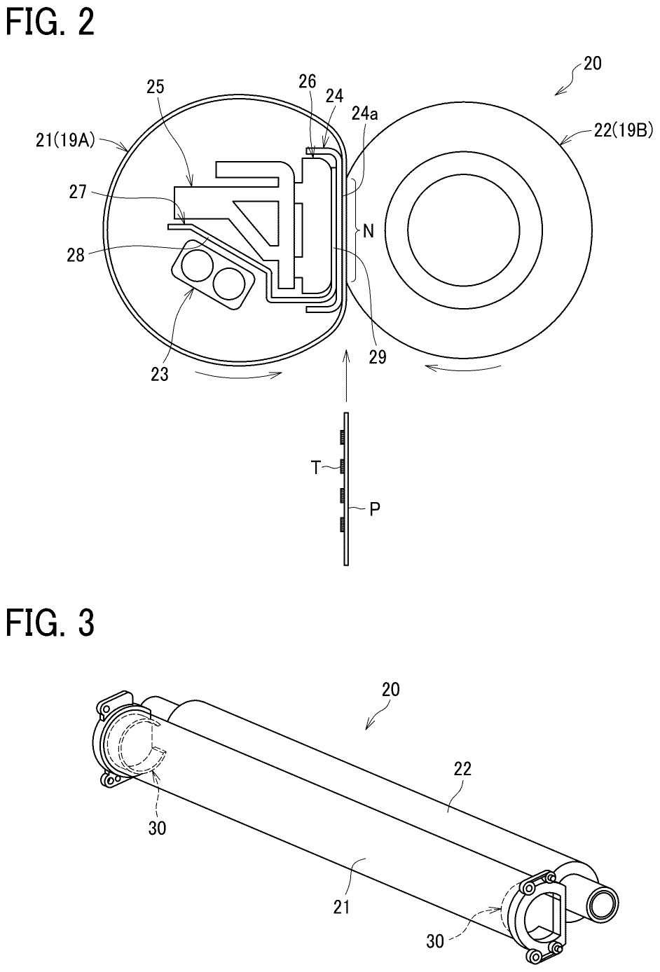

FIG. 2 is a schematic configuration diagram of the fixing device 20.

As illustrated in FIG. 2, the fixing device 20 includes, in addition to the pair of rotators 19A and 19B, a halogen heater 23, a nip forming member 24, a support 25, a base 26, and a reflector 27.

The rotators 19A and 19B are formed of, respectively, a fixing belt 21 and a pressure roller 22. Herein, the fixing belt 21 corresponds to a first rotator, whereas the pressure roller 22 corresponds to a second rotator.

The fixing belt 21 is disposed adjacent to the surface of the sheet P on which an unfixed image (toner image T) has been formed. The fixing belt 21 is formed of an endless belt including a substrate, an elastic layer, a release layer, and some other layers in this order from the inside. The substrate has a thickness of 30 to 50 μm, for example, and is made of a metal material, such as nickel or stainless steel, or a resin material, such as polyimide. The elastic layer has a thickness of 100 to 300 μm and is formed of a rubber material, such as silicone rubber, foam silicone rubber, or fluoro rubber. With the fixing belt 21 having the elastic layer, fine irregularities are less likely to be formed on the surface of the fixing belt 21. In this case, the heat is transferred further uniformly to the toner image T on the sheet P. The release layer has a thickness of 10 to 50 μm and is made of a material such as tetrafluoroethylene-perfluoroalkyl vinyl ether copolymer (PFA), polytetrafluoroethylene (PTFE), polyimide, polyetherimide, or polyether sulfide (PES). With the fixing belt 21 having the release layer, the fixing belt 21 can be reliably released from the toner image T on the sheet P. In addition, to achieve the compactness and a low heat capacity, the fixing belt 21 preferably has an entire thickness of 1 mm or less and a diameter of 30 mm or less.

The pressure roller 22 is disposed so as to face the outer surface of the fixing belt 21. The pressure roller 22 is formed of a roller including a core material, an elastic layer on the outer surface of the core material, a release layer on the outer surface of the elastic layer, and some other layers. The core material is formed of, for example, a metal material, such as iron. The core member may be either a solid or hollow member. The cross section of the core material may be circular or rectangular or another in shape. Examples of the material of the elastic layer include silicone rubber, foam silicone rubber, and fluororubber. The silicone rubber may be either solid or sponge rubber. The sponge rubber is preferable because the sponge rubber helps enhance the thermal insulation, thereby making the heat of the fixing belt 21 less likely to be released by the pressure roller 22. The release layer is formed of, for example, a fluororesin, such as PFA or PTFE.

The pressure roller 22 is pressed against the fixing belt 21 by a pressure component, such as a spring. With this pressure component, the pressure roller 22 is brought into contact with the outer surface of the fixing belt 21 to form a nip portion N at a position where the pressure roller 22 is in contact with the fixing belt 21. As illustrated in FIG. 2, when the pressure roller 22 rotates, the fixing belt 21 is rotated together with the pressure roller 22. Then, when the sheet P carrying the toner image (unfixed image) T enters the nip portion N while the fixing belt 21 is heated to a predetermined target temperature, the fixing belt 21 and the pressure roller 22 rotate and simultaneously heat and apply pressure to the sheet P. The toner image T is thereby fixed onto the sheet P.

The halogen heater 23 is a radiation type of heating source that radiates heat (infrared rays) to heat the fixing belt 21. When the heat is radiated from the halogen heater 23, the fixing belt 21 is heated from the inside. The heating source is not limited to a halogen heater and may be another radiation type of heater, such as a carbon heater. If the pressure roller 22 does not have an elastic layer made of sponge rubber, a heating source, such as a halogen heater, may also be disposed inside the pressure roller 22.

The nip forming member 24 is a member that is in contact with the inner face of the fixing belt 21 and forms the nip portion N between the fixing belt 21 and the pressure roller 22. To apply pressure to the fixing belt 21, the pressure roller 22 presses the nip forming member 24 with the fixing belt 21 therebetween. At this time, the fixing belt 21 is pressed between the pressure roller 22 and the nip forming member 24. In this case, the fixing belt 21 is deformed in conformity with the shape of the nip forming member 24 to form the nip portion N. In the example of FIG. 2, the nip portion N is formed into a planar shape; however, the nip portion N may have a curved surface recessed toward the fixing belt 21 or may have another shape.

The nip forming member 24 is made of a metal material, such as aluminum or copper, which has a high heat conductivity of 50 W/m·K or more. Thus, when the temperature of the fixing belt 21 is nonuniform in a longitudinal direction thereof, the heat is transferred from a higher temperature portion to a lower temperature portion of the fixing belt 21 via the nip forming member 24. This can suppress the nonuniformity of the temperature of the fixing belt 21. In short, the nip forming member 24 also functions as a member that assists the heat transfer, via which the heat of the fixing belt 21 is transferred in the longitudinal direction.

To facilitate the sliding property of the fixing belt 21 over the nip forming member 24, a sliding layer having high sliding performance is preferably formed on a surface 24a of the nip forming member 24 which faces the inner face of the fixing belt 21. One example of the material of this sliding layer is a resin-based material, such as a polyimide resin, a fluororesin, a polyphenylene sulfide resin, or a saturated polyester resin. Alternatively, such a resin-based material may be mixed with glass fiber, carbon, graphite, graphite fluoride, carbon fiber, molybdenum disulfide, fluororesin, or some other materials.

The sliding layer may be made of a metal-based material. Examples of the metal-based material include molybdenum disulfide, nickel, composite plating of nickel and a fluororesin, alumite, and a material obtained by impregnating alumite with a resin or a metal. In addition, the material of the sliding layer may be ceramic. Examples of the ceramic used as the sliding layer include a silicon carbide ceramic, a silicon chamber ceramic, an alumina ceramic, and a mixture thereof with molybdenum disulfide, a fluororesin, or some other types of ceramic.

When the nip forming member 24 is made of aluminum or an aluminum alloy, an alumite layer may be formed on the surface layer of the nip forming member 24, and fine pores of the alumite layer may be filled with molybdenum disulfide generated by secondary electrolysis from the deepest portion to the outermost layer of the fine pores.

The support 25 is a member that supports the nip forming member 24, the base 26, and the reflector 27 and receives pressure of the pressure roller 22 via the nip forming member 24 or some other components. The support 25 receives the pressure of the pressure roller 22 to suppress the nip forming member 24 and some other components from being bent, thereby providing the nip portion N with a uniform width. The support 25 is preferably made of a metal material, such as iron or stainless steel, in terms of sufficient rigidity.

The base 26 is a member disposed between the support 25 and the nip forming member 24. The base 26 is made of, for example, a heat-resistant resin, such as polyether sulfone (PES), polyphenylene sulfide (PPS), liquid crystal polymer (LCP), polyether nitrile (PEN), polyamide imide (PAI), or polyether ether ketone (PEEK). Being made of resin, the base 26 functions as a heat-insulating member, which suppresses the heat transfer from fixing belt 21 to the support 25.

The reflector 27, which is disposed inside the fixing belt 21, is a member that reflects the heat of the halogen heater 23 to the inner face of the fixing belt 21. The reflector 27 includes: a reflecting section 28 disposed so as to face the halogen heater 23; and a heat transmission section 29 disposed so as to be pressurized between the base 26 and the nip forming member 24.

The reflecting section 28 is a section that reflects the heat of the halogen heater 23 toward the inner face of the fixing belt 21. The heat reflected by the reflecting section 28 is given to the inner face of the fixing belt 21. As a result, the fixing belt 21 is effectively heated by both the reflected heat and the heat directly given from the halogen heater 23. In addition, the reflecting section 28, which is disposed between the halogen heater 23 and the support 25, suppresses unnecessary heat from being applied to the support 25. This can contribute to decreased energy consumption.

The heat transmission section 29 is a section that is in contact with the nip forming member 24 and transmits the heat of the reflector 27 (reflecting section 28) to mainly the nip forming member 24. The heat transmission section 29 may be in direct contact with the nip forming member 24 or may be in indirect contact with the nip forming member 24 via a heat conduction member or another member.

Herein, examples of a reflector used in a fixing device include: a reflector in which multiple enhanced reflection films and protective films are formed on a surface layer of a base substrate made of a high-purity aluminum material; and a reflector in which silver is vapor-deposited on a surface of an aluminum plate in order to improve the reflectance. Nevertheless, the temperature of the reflector is prone to increase with time because the reflector is exposed to heat of a heating source, such as a halogen heater. The reflector may be exposed to heat for a long time, especially when many sheets are sequentially fed. As a result, the temperature of the reflector may increase from about 300 to 400° C. If the aluminum or silver deposited layer on the surface of the reflector is discolored as a result of an excessive temperature increase in the reflector, the heat reflectance of the reflector may decrease to the extent that it is impossible to produce a desired heating effect. In addition, an excessive temperature increase in the reflector is not preferable in terms of safety. Therefore, any measures have been conventionally taken to adjust the productivity (image forming speed) of image forming apparatuses in such a way that the temperatures of the reflectors do not excessively increase. In this case, however, the productivity cannot be exhibited so as to exceed the heat resistances of the reflectors. Thus, the heat resistance of the reflector can be a limitation on an improvement in productivity.

To address such problems, as illustrated in FIG. 2, the present embodiment employs a configuration in which the reflector 27 is elongated so that a part (heat transmission section 29) of the reflector 27 is in contact with the nip forming member 24, in order to control an increase in temperature of the reflector. In short, the reflector 27 has the heat transmission section 29 that is in contact with the nip forming member 24. Thus, when the reflecting section 28 receives the heat from the halogen heater 23 and thus the temperature thereof increases, the heat of the reflecting section 28 is transferred to the nip forming member 24 via the heat transmission section 29. The heat transmission section 29 is in contact with the nip forming member 24 as well as the base 26. However, the heat of the reflector 27 is transferred to the nip forming member 24 more preferentially than to the base 26. This is because the material of the base 26 is lower in heat conductivity than the material of the nip forming member 24. In addition, the heat transmission section 29 is disposed and pressurized between the nip forming member 24 and the base 26. This configuration provides good adhesion between the heat transmission section 29 and the nip forming member 24, thereby transferring the heat at a higher rate from the heat transmission section 29 to the nip forming member 24. Consequently, it is possible to control a temperature increase in the reflector 27, thus preventing the reflecting section 28 from being discolored due to the heat.

As described above, the present embodiment employs a configuration in which the heat of the reflector 27 (reflecting section 28) can be transferred to the nip forming member 24. This configuration can control an increase in temperature of the reflector 27 during feeding of sheets, thereby improving the productivity of the image forming apparatus. After having been transferred to the nip forming member 24 via the heat transmission section 29, the heat is further transmitted to the fixing belt 21 via the nip forming member 24. In the present embodiment, thus, the heat of the reflector 27 can be effectively used as heating energy of the fixing belt 21, which is expected to improve energy saving.

Problem with Fixing Device Having Reflector

Next, another problem with the fixing device having the reflector will be described using the present embodiment as an example.

In the present embodiment, as described above, the reflector 27 is so elongated that a part (heat transmission section 29) of the reflector 27 is in contact with the nip forming member 24. This configuration, when the temperature of the reflector 27 increases, enables the heat of the reflector 27 to be transferred to the nip forming member 24. In some cases, however, when the temperature of the fixing belt 21 increases, the heat of the fixing belt 21 is transferred to the reflector 27 via the nip forming member 24.

For example, when the image forming apparatus that has been in a state where the fixing device has a low temperature starts to perform a warm-up operation or a return operation, such as when the power of the image forming apparatus is turned on or when the image forming apparatus returns from a long sleep state, the temperature of the fixing belt 21 may exceed both the temperatures of the nip forming member 24 and the reflector 27. This is because the temperature of the fixing belt 21 increases at a higher rate than both the temperatures of the nip forming member 24 and the reflector 27. In this case, the heat is transferred from the fixing belt 21 to both the nip forming member 24 and the reflector 27, so that the temperature of the fixing belt 21 decreases.

More specifically, since the fixing belt 21 is supported on both the longitudinal sides by a pair of rotator supports 30 as illustrated in FIG. 3, the heat of the fixing belt 21 escapes to the side plates and some other portions via the rotator supports 30. Thus, the temperature of the longitudinal sides of the fixing belt 21 tends to decrease at a higher rate. The decrease in the temperature of the longitudinal sides of the fixing belt 21 may cause a fixing defect, referred to as a cold offset, in which some portions of the image are lacking without being fixed onto a sheet.

Since the reflector 27 receives the heat of the halogen heater 23 to thermally expand, the reflector 27 may interfere with some peripheral members. Therefore, the reflector 27 is preferably positioned in advance.

If fixed to and positioned with respect to a peripheral member, the reflector 27 is restrained upon heat expansion, in which case both the reflector 27 and the peripheral member may be deformed. Moreover, since the heat of the reflector 27 is transmitted to the peripheral member via a fixing portion between the reflector 27 and the peripheral member, the heat transmitted from the reflector 27 to the fixing belt 21 decreases. Thus, the concern may arise that energy saving is impaired. Therefore, there is a demand to reduce a number of the fixing portions (positioning portions) of the reflector 27 to the peripheral member to minimum.

Regarding positioning of the reflector 27, it is necessary to consider the following circumstances. For example, if a double-sided adhesive tape is used as a positioning component, this double-sided adhesive tape is interposed between the reflector 27 and the nip forming member 24. This configuration may hinder the heat from being transmitted from the reflector 27 to the nip forming member 24 due to low heat conductivity of double-sided adhesive tape. Furthermore, the joint surfaces of the reflector 27 and the nip forming member 24 may be shifted from each other due to a difference in heat expansion therebetween. Thus, such a double-sided adhesive tape is not suitable for use as a positioning component at the position at which the joint surfaces may be shifted. Therefore, a mechanism for positioning the reflector 27 is requested not to hinder the heat transmission from the reflector 27 to the nip forming member 24 and to be less subject to the shifting of the joint surfaces due to a difference in heat expansion.

In view of the above circumstances, a fixing device employs the following configuration in order to control a decrease in temperature at both ends of a fixing belt in a longitudinal direction thereof and to appropriately position a reflector. Hereinafter, the configurations of some feature parts will be described.

### Configuration of Feature Parts of Fixing Device

A description will be first given of a configuration of the fixing device which controls a decrease in temperature of the longitudinal sides of a fixing belt.

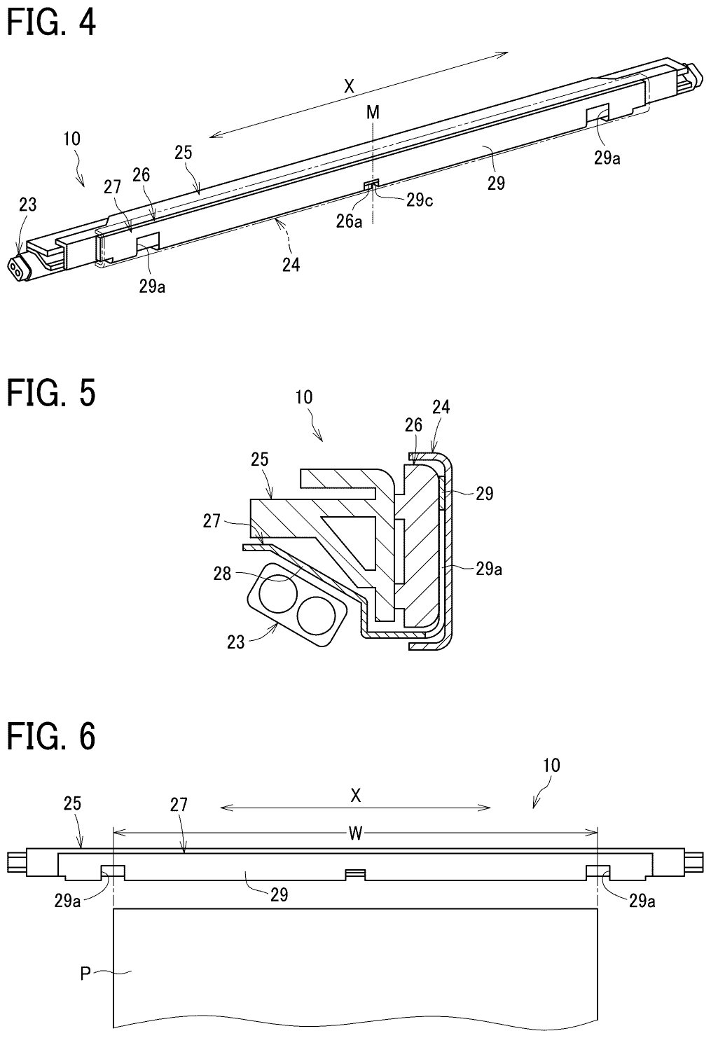

FIG. 4 is a perspective view of a heating unit disposed inside the fixing belt of the fixing device.

A heating unit 10 is a unit that includes, in addition to the halogen heater 23, the reflector 27, the base 26, the support 25, and the nip forming member 24. In FIG. 4, the nip forming member 24 is indicated by a two-dot chain line.

As illustrated in FIG. 4, each of the halogen heater 23, the reflector 27, the base 26, the support 25, and the nip forming member 24 is formed into an elongated shape so as to extend in a direction of arrow X in the drawing. Specifically, a longitudinal center M of each of the nip forming member 24 and the heat transmission section 29 of the reflector 27 is disposed so as to be aligned with a longitudinal center of the fixing belt. In this arrangement, when the temperature of the reflector 27 increases, the heat of the reflector 27 is applied to the fixing belt symmetrically with respect to a longitudinal center thereof via both the heat transmission section 29 and the nip forming member 24.

When the temperature of the fixing belt exceeds both the temperatures of the nip forming member 24 and the reflector 27, the heat of the fixing belt is transferred to both the nip forming member 24 and the reflector 27. In this case, the temperature of the longitudinal sides of the fixing belt tends to significantly decrease, for example, due to the influence of the heat transfer to the rotator supports 30 (see FIG. 3).

For the above reason, the present embodiment provides a pair of holes 29a on the longitudinal sides of the heat transmission section 29 with respect to the longitudinal center M thereof, as illustrated in FIG. 4, in order to control a decrease in temperature of the longitudinal sides of the fixing belt. In this case, the holes 29a are arranged symmetrically on the respective longitudinal sides of the heat transmission section 29 with respect to the longitudinal center M thereof.

FIG. 5 is a cross-sectional view of the heating unit 10 cut at a position (the position of a hole 29a) on one longitudinal side thereof.

At the position of each hole 29a, as illustrated in FIG. 5, a gap (air layers), the size of which is related to the size of the holes 29a, are interposed between the nip forming member 24 and the base 26. In short, the heat transmission section 29 is not present at the position of each hole 29a. Thus, the heat transmission section 29 is not in contact with the nip forming member 24 at this position.

As described above, with the holes 29a on the respective longitudinal sides of the heat transmission section 29, the total area of the longitudinal sides of the heat transmission section 29 in contact with the nip forming member 24 can be made smaller than the contact area of the remaining portion of the heat transmission section 29 containing the longitudinal center M. In other words, when the heat transmission section 29 is cut in a direction orthogonal to the longitudinal direction X, the range of the heat transmission section 29 in contact with the nip forming member 24 at the position of each hole 29a can be made smaller than the contact range of the other portion thereof containing the longitudinal center M.

This configuration suppresses the heat transfer between the nip forming member 24 and the heat transmission section 29 on the longitudinal sides of the heat transmission section 29. As a result, even when the temperature of the fixing belt exceeds both the temperatures of the nip forming member 24 and the reflector 27, the configuration suppresses the heat transfer from the fixing belt to both the nip forming member 24 and the reflector 27. With the present embodiment, it is possible to control a decrease in temperature on the longitudinal sides of the fixing belt, thereby preventing an occurrence of the cold offset.

In the example of FIG. 4, the holes 29a are arranged symmetrically with respect to the longitudinal center M of the heat transmission section 29. However, if actual locations of the fixing belt at which the temperature is likely to decrease are not symmetrical, the holes 29a may also be arranged asymmetrically correspondingly. Furthermore, the shape of the holes 29a is not limited to a rectangular shape, unlike the example of FIG. 4 and may be a circular or other shape.

In addition to being arranged at actual locations at which the temperature of the fixing belt is actually likely to decrease, the hole 29a is preferably arranged in relation to a width (sheet passage width) of a sheet passing through the nip portion N. As illustrated in FIG. 6, for example, the holes 29a may be disposed on or close to both the sides of a sheet passage width (sheet passage width) W of a sheet P, which has a standard size, such as “A4”, expected to be used frequently. This configuration can prevent the cold offset on the sides, in the width direction, of sheets to be used frequently, thereby further effectively preventing an occurrence of a fixing failure.

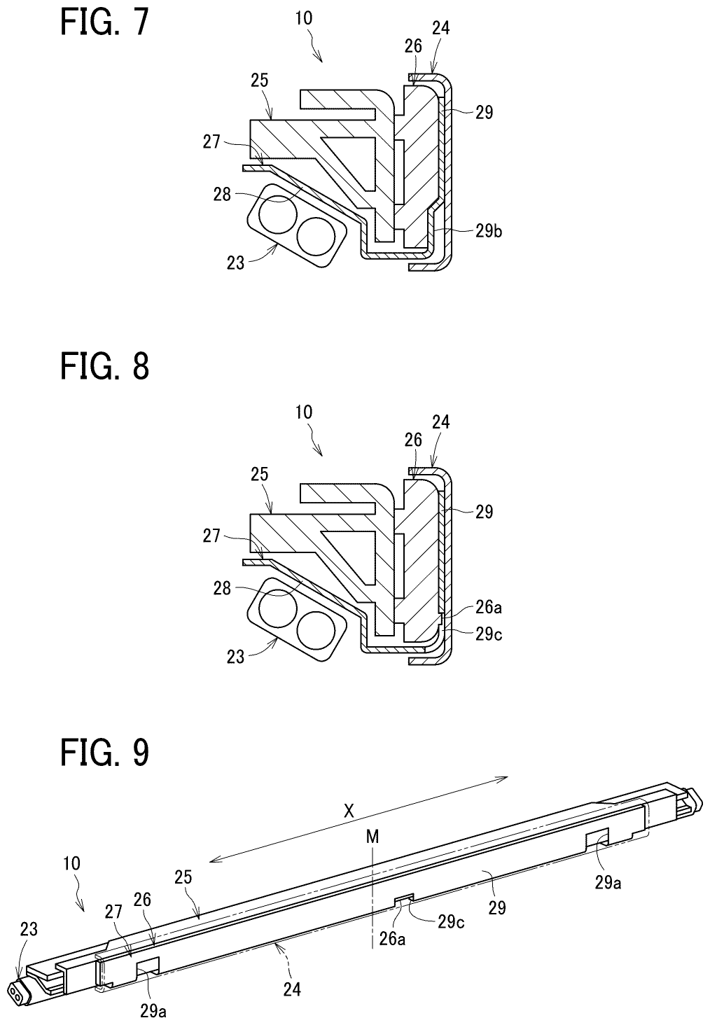

In the example illustrated in FIGS. 4 and 5, each hole 29a is formed as a through-holes passing though the heat transmission section 29. Instead of the through-holes, however, recesses 29b (not passing through the heat transmission section 29) may be provided on the respective longitudinal sides of the heat transmission section 29, as in a modification illustrated in FIG. 7. In this configuration, the total area of the heat transmission section 29 provided with the recesses 29b which is in contact with the nip forming member 24 is also made smaller. Thus, when the temperature of the fixing belt increases, it is possible to suppress the heat transfer from the fixing belt to both the nip forming member 24 and the reflector 27.

The holes 29a and the recesses 29b are also referred to as “end sections” that are disposed at both ends of the heat transmission section 29.

Next, a description will be given of a configuration of the fixing device by which the reflector 27 is positioned.

As illustrated in FIG. 4, the reflector 27 has a positioning hole 29c at the longitudinal center M or at a vicinity of the longitudinal center M of the heat transmission section 29 in order to position the reflector 27 with respect to the base 26. The positioning hole 29c is an example of a positioning section through which the reflector 27 is to be positioned. Moreover, the base 26 has a positioning projection 26a as a positioning section for a counterpart member.

FIG. 8 is a cross-sectional view of the heating unit 10 cut at the longitudinal center M (at the position of the positioning hole 29c).

As illustrated in FIG. 8, the positioning hole 29c is formed across the heat transmission section 29. Thus, when the heat transmission section 29 is pressurized between the nip forming member 24 and the base 26, the positioning projection 26a of the base 26 is inserted into the positioning hole 29c of the heat transmission section 29. While the positioning projection 26a is inserted into the positioning hole 29c, the positioning projection 26a is in a state of engaging or being engageable with the portion around the positioning hole 29c in the longitudinal direction X. With this configuration, the reflector 27 is positioned in the longitudinal direction X with respect to the base 26.

In the present embodiment, as described above, the heating unit 10 is configured such that the positioning projection 26a and the positioning hole 29c are in a state of engaging or being engageable with each other. With this configuration, the reflector 27 can be positioned in the longitudinal direction X. In the present embodiment, as illustrated in FIG. 4, with the configuration in which the positioning hole 29c is provided in the heat transmission section 29 at the longitudinal center M, the reflector 27 can be precisely positioned. Specifically, the longitudinal center M of the heat transmission section 29 is a portion through which various types of sheets having different width sizes are to pass and is also a range to be subjected to temperature control. In this configuration, the temperature of the longitudinal center M does not vary largely. Therefore, a dimension thereof does not vary largely in the longitudinal direction X in relation to heat expansion. Thus, by setting the longitudinal center M as the reference position for the positioning, it is possible to reduce the influence of the dimensional variations in relation to the heat expansion, thereby enabling the reflector 27 to be positioned more precisely. According to the present embodiment, it is possible to effectively suppress the reflector 27 from interfering with some peripheral members even when the reflector 27 thermally expands.

It should be noted that the positioning hole 29c does not have to be necessarily provided at the longitudinal center M of the heat transmission section 29; alternatively, the positioning hole 29c may be positioned shifted from the longitudinal center M toward either side in the longitudinal direction X, as illustrated in FIG. 9. More specifically, the positioning hole 29c may be positioned shifted from the longitudinal center M as long as this position is closer to the center M than each hole 29a in the longitudinal direction, although the positioning hole 29c is preferably positioned at the longitudinal center M.

The positioning hole 29c is a positioning section disposed at a vicinity of a center of the heat transmission section in the longitudinal direction. The positioning section positions the reflector with respect to the base, and the positioning section has a first contacting area contacting with the nip forming member. The end sections have holes 29a or recesses that are closer to both ends of the heat transmission section than the positioning section (positioning hole 29c) in the longitudinal direction. Each of the end sections has a second contacting area smaller than the first contacting area to contact with the nip forming member 24.

In the present embodiment, the heating unit 10 is configured such that the engaging of the positioning projection 26a with the positioning hole 29c causes the reflector 27 to be positioned in the longitudinal direction X. In addition, applying pressure to the reflector 27 between the base 26 and the nip forming member 24 maintains this engagement. The configuration in the present embodiment thus can involve using a smaller number of fixing portions than a configuration in which the reflector 27 is positioned by being fixed to the support 25 or some other components. As a result, this configuration can suppress the reflector 27 and some peripheral members from being deformed when the reflector 27 is restrained due to heat expansion. This configuration can suppress unnecessary heat transmission from the reflector 27 to the peripheral members. Therefore, with the present embodiment, it is possible to prevent the reflector 27 and the peripheral members from being deformed, thereby reducing the risk of damage thereto. In addition, it is possible to reliably transmit heat from the reflector 27 to the fixing belt, thereby improving energy saving.

In the present embodiment, the heating unit 10 is configured such that a counterpart member with respect to which the reflector 27 is positioned is not a highly heat conductive member, such as the nip forming member 24 or the support 25. Instead, the counterpart member is the base 26 made of resin, which is lower in heat conductivity than both the nip forming member 24 and the support 25. This configuration suppresses heat transmission from the reflector 27 to the peripheral member via the location at which the reflector 27 is positioned. Furthermore, the configuration can suppress unnecessary heat transmission from the reflector 27 to the peripheral member and can transmit the heat at a higher rate from the reflector 27 to the fixing belt, thereby improving energy saving. In the present embodiment, the heating unit 10 is configured such that the positioning hole 29c has a smaller opening area than the opening area of the holes 29a. This configuration can control a decrease in heat conductivity between the heat transmission section 29 and the nip forming member 24 due to the provision of the positioning hole 29c (i.e., due to a decrease in the contact area between the heat transmission section 29 and the nip forming member 24).

In the present embodiment, the heating unit 10 is configured such that the reflector 27 is positioned by the engaging of the positioning projection 26a with the positioning hole 29c without using a double-sided adhesive tape. This configuration can reliably transmit the heat from the reflector 27 to the nip forming member 24 and can appropriately maintain the positioning of the reflector 27. With the present embodiment, it is possible to suppress poor heat transmission from the reflector 27 to the nip forming member 24, as opposed to a case where the reflector 27 is positioned with respect to the nip forming member 24 with a double-sided adhesive tape. In addition, it is possible to suppress an occurrence of a positioning failure due to the shifting of the joint surfaces. This configuration can transmit the heat at a higher rate from the reflector 27 to the nip forming member 24 and enables the reflector 27 to be appropriately positioned.

As illustrated in FIG. 8, the positioning projection 26a is preferably formed so as not to protrude from the positioning hole 29c toward the nip forming member 24. In other words, the protruding amount (height) of the positioning projection 26a is preferably equal to or less than the depth of the positioning hole 29c or equal to or less than the thickness of the heat transmission section 29. The configuration in which the positioning projection 26a does not protrude from the positioning hole 29c toward the nip forming member 24, as described above, can suppress interference between the positioning projection 26a and the nip forming member 24.

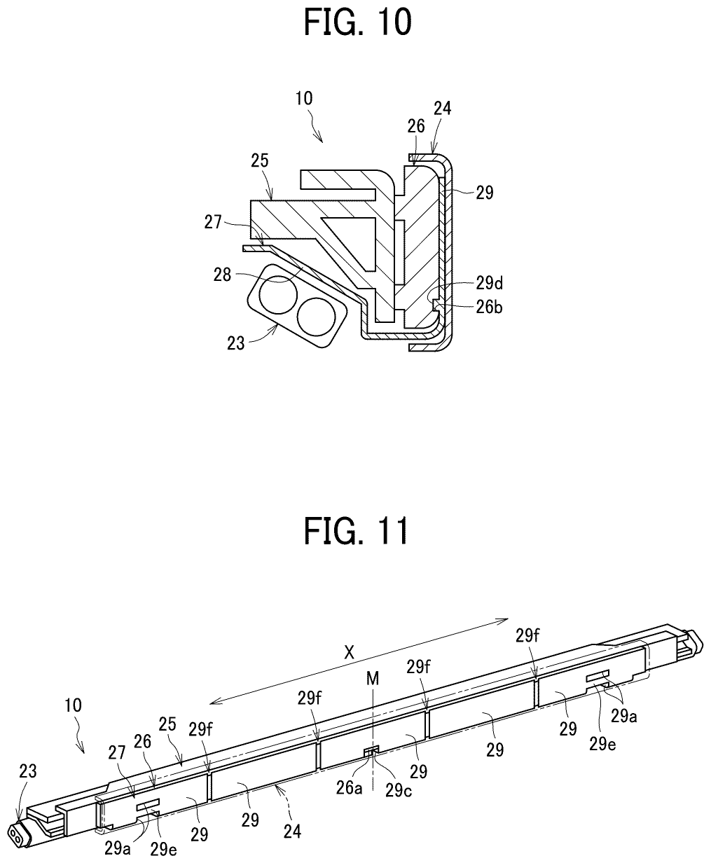

As in the example of FIG. 10, the coupling relationship between a positioning section of the reflector 27 and a counterpart positioning section of the base 26 may be opposite to the above. More specifically, the reflector 27 may be provided with a positioning projection 29d, whereas the base 26 may be provided with a positioning hole 26b.

Next, some other embodiments of the present disclosure will be described. In the following description, differences from the first embodiment of the present disclosure will be mainly described, and description of the same portions will be omitted as appropriate.

### Second Embodiment of Present Disclosure

FIG. 11 is a perspective view of a heating unit 10.

In the second embodiment of the present embodiment, as illustrated in FIG. 11, two holes 29a of heat transmission sections 29 are arranged separately from each other in a direction intersecting a longitudinal direction X of each heat transmission section 29. Between the two separated holes 29a, heat transfer assist sections 29e extending in the longitudinal direction X of the heat transmission section 29 are provided.

Each heat transfer assist section 29e forms a portion of a surface (nip-side facing surface) of a corresponding heat transmission section 29 facing a nip forming member 24. Therefore, when the heat transmission sections 29 are pressurized between the nip forming member 24 and a base 26, the heat transfer assist sections 29e come into contact with the nip forming member 24. The configuration in which the heat transfer assist sections 29e come into contact with the nip forming member 24 in this manner promotes the heat transfer between the nip forming member 24 and each heat transmission section 29 via the heat transfer assist sections 29e, in the second embodiment of the present embodiment.

On the other hand, the configuration in which the holes 29a are provided in some of the heat transmission sections 29 can suppress the heat transfer from the fixing belt to the reflector 27 when the temperature of the fixing belt increases. However, this configuration may hinder the heat transfer from each heat transmission section 29 to the nip forming member 24 when the temperature of the reflector 27 increases. In the second embodiment of the present embodiment, the heating unit 10 is thus configured such that the heat transfer assist sections 29e are provided between the holes 29a to mitigate the inhibition of the heat transfer from each heat transmission section 29 to the nip forming member 24. More specifically, providing the heat transfer assist sections 29e increases the total area of the heat transmission sections 29 in contact with the nip forming member 24. This configuration can promote the heat transfer from each heat transmission section 29 to the nip forming member 24 when the temperature of the reflector 27 increases.

Each heat transfer assist section 29e may be in either direct or indirect contact with the nip forming member 24, similar to the other portions of each heat transmission section 29. The holes 29a on both sides of the corresponding heat transfer assist sections 29e may have the same size and shape or mutually different sizes and shapes.

As illustrated in FIG. 11, multiple heat transmission sections 29 may be divided from one another and arranged separately from one another in the longitudinal direction X. In this case, gaps 29f are interposed between the separated or divided heat transmission sections 29, so that the heat transmission sections 29 are spaced from one another in the longitudinal direction X.

The configuration in which the multiple heat transmission sections 29 is separated from one another in the longitudinal direction X in the above manner can mitigate variations in the dimension of the heating unit 10 when the heat transmission section 29 thermally expands as well as the deformation of the heating unit 10 in relation to such dimensional variations. In this case, even when the heat transmission section 29 thermally expands, the gaps 29f between the heat transmission sections 29 can absorb an increasing dimension of each heat transmission section 29 in the longitudinal direction X. This configuration thus can mitigate overall dimensional variations from the heat transmission section 29 disposed at one end to the heat transmission section 29 located at the other end as well as deformation in relation to such dimensional variations. Consequently, it is possible to more reliably suppress interference between the reflector 27 and some peripheral members.

The number of heat transmission sections 29 separated and locations at which the heat transmission sections 29 are separated can be appropriately changed; however, the heat transmission sections 29 is preferably separated on or adjacent to both the sides of the sheet passage width of a sheet to be used. With the configuration in which the separated locations are positioned at or adjacent to the sides of the sheet passage width, the difference between the heat transmissions from one to another of the heat transmission sections 29 via the gaps 29f and via the other portions thereof can be suppressed from influencing an image forming region of a sheet. Consequently, it is possible to prevent an occurrence of a fixing failure, such as gloss unevenness.

### Third Embodiment of Present Disclosure

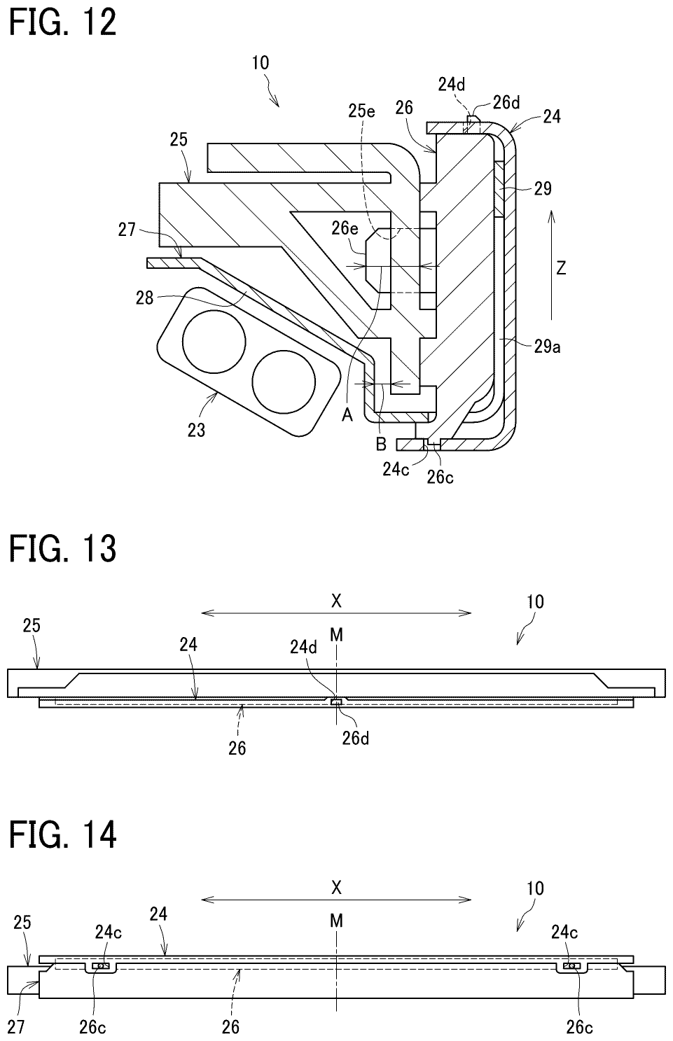

Next, a third embodiment of the present embodiment will be described with reference to FIGS. 12 to 14.

FIG. 12 is a cross-sectional view of a heating unit 10. FIG. 13 is a view of the heating unit 10 as viewed from a downstream side in a sheet conveyance direction. FIG. 14 is a view of the heating unit 10 as viewed from an upstream side in the sheet conveyance direction. It should be noted that in FIG. 12, the sheet conveyance direction corresponds to the direction of arrow Z.

Furthermore, in FIGS. 13 and 14, a halogen heater 23 is omitted.

In the third embodiment of the present embodiment, as illustrated in FIG. 12, an upstream end and downstream end of a base 26 in the sheet conveyance direction Z have, respectively, engagement projections 26c and an engagement projection 26d, all of which engage with the nip forming member 24. In addition, the upstream end and downstream end of the nip forming member 24 have, respectively, engagement holes 24c and 24d, with which the engagement projections 26c and 26d of the base 26 engage. In this case, each of the engagement holes 24c and 24d is formed of a through-hole passing through the nip forming member 24; however, each of the engagement holes 24c and 24d may be a recess (engagement recess) that does not pass through the nip forming member 24.

As illustrated in FIG. 12, the engagement projections 26c and 26d of the base 26 engage with the engagement holes 24c and 24d of the nip forming member 24, thereby fixing the nip forming member 24 to the base 26. In this state, a reflector 27 is pinched between the base 26 and the nip forming member 24, so that the reflector 27 is held between the base 26 and the nip forming member 24.

A certain fixing device is configured such that the pressure between a fixing belt and a pressure roller can be released in order to facilitate a process of removing a sheet that has been jammed in a nip portion. Once this pressure is released, the pressure between the base 26 and the nip forming member 24 that pinch the reflector 27 therebetween is also released. In this case, the reflector 27 may accidentally fall off from between the base 26 and the nip forming member 24 in response to the release of the pressure. Provided that the reflector 27 falls off and comes into contact with the inner face of a fixing belt, the reflector 27 may scratch a coating layer provided on the inner face of the fixing belt in order to increase the sliding property and heat absorption efficiency of the fixing belt. This accident might lower the sliding property and heat absorption efficiency of the fixing belt, hindering the fixing device from providing desired functions.

In the third embodiment of the present embodiment, the heating unit 10 is configured such that the base 26 and the nip forming member 24 can engage with each other and such that the reflector 27 is pinched between the base 26 and the nip forming member 24 that engage with each other. The configuration in which the reflector 27 is pinched between the base 26 and the nip forming member 24 in this manner reduces the risk of the reflector 27 accidentally falling off even when the pressure between the fixing belt and the pressure roller is released. Consequently, it is possible to prevent the reflector 27 from accidentally falling off and scratching the inner face of the fixing belt, thereby appropriately ensuring the functions of the fixing belt and improving reliability.

In the third embodiment of the present embodiment, as illustrated in FIG. 13, the heating unit 10 is configured such that both the engagement hole 24d and the engagement projection 26d on the downstream side are disposed at a longitudinal center M of the nip forming member 24 and the base 26. Since the engagement hole 24d and the engagement projection 26d on the downstream side are disposed at the longitudinal center M as described above, the dimensions thereof are less likely to vary in relation to the heat expansion. This configuration enables both the base 26 and the nip forming member 24 to be positioned precisely at the longitudinal center M. Furthermore, both the reflector 27 and the nip forming member 24 are also positioned at the longitudinal center M (see FIG. 4) similar to the foregoing embodiment. This configuration thus also enables both the reflector 27 and the nip forming member 24 to be positioned precisely at the longitudinal center M. As described above, the positioning of the reflector 27 relative to the nip forming member 24 and the positioning of the base 26 relative to the nip forming member 24 are performed with respect to the longitudinal center M. This configuration enables all of the reflector 27, the nip forming member 24, and the base 26 to be positioned precisely relative to one another, thereby effectively suppressing interference between these members.

As illustrated in FIG. 14, the engagement holes 24c and the engagement projections 26c on the upstream side are arranged closer to both the ends of the nip forming member 24 and the base 26 than the longitudinal center M in the longitudinal direction. The dimension of each of the nip forming member 24 and the base 26 is more likely to vary at both the ends than at the longitudinal center M in the longitudinal direction in relation to heat expansion. Therefore, gaps are preferably formed in the nip forming member 24 between the engagement holes 24c and the base 26 and between the engagement projections 26c on the upstream side, in order to suppress interference therebetween during the heat expansion. In the third embodiment of the present embodiment, the engagement holes 24c are each formed of a hole that is longer than the engagement projections 26c. The engagement hole 24d and the engagement projection 26d on the downstream side are disposed at the longitudinal center M where dimensions thereof are less likely to vary due to heat expansion. Thus, a hole forming the engagement hole 24d and a projection forming the engagement projection 26d have the same size.

However, the engagement hole 24d and the engagement projection 26d on the downstream side may be disposed shifted from the longitudinal center M toward either end in the longitudinal direction, although the engagement hole 24d and the engagement projection 26d are preferably disposed at the longitudinal center M. More specifically, the engagement hole 24d and the engagement projection 26d on the downstream side may be disposed shifted from the longitudinal center M as long as the engagement hole 24d and the engagement projection 26d are disposed closer to the longitudinal center M than the engagement holes 24c and the engagement projections 26c on the upstream side are.

In the third embodiment of the present embodiment, the heating unit 10 is configured such that a heat transmission section 29 has a pair of holes 29a at both ends thereof in the longitudinal direction, similar to the foregoing embodiment (see FIG. 4). In the third embodiment of the present embodiment, as illustrated in FIG. 12, the heating unit 10 is thus configured such that the engagement projections 26c on the upstream side which are disposed at the ends in the longitudinal direction protrude toward the nip forming member 24 (engagement hole 24c) through the holes 29a disposed likewise at the ends of the heat transmission section 29 in the longitudinal direction. In the third embodiment of the present embodiment, as described above, the engagement projections 26c on the upstream side protrude toward the nip forming member 24 through the holes 29a of the heat transmission section 29. In this case, the heat transmission section 29 does not have to be additionally provided with dedicated holes through which the engagement projections 26c on the upstream side protrude. This configuration can suppress an area of the heat transmission section 29 in contact with the nip forming member 24 from being decreased due to additional provision of dedicated holes in the heat transmission section 29. It is thus possible to control a decrease in the heat transmission efficiency from the heat transmission section 29 to the nip forming member 24 due to the decreased contact area.

In the third embodiment of the present embodiment, as illustrated in FIG. 12, the heating unit 10 is configured such that the base 26 has a fitting projection 26e by which the base 26 is positioned with respect to the support 25. The support 25 has a fitting hole 25e through which the fitting projection 26e of the base 26 fittingly passes.

In FIG. 12, the insertion amount by which the fitting projection 26e is inserted into the fitting hole 25e in an insertion direction is denoted by A. When the fitting projection 26e moves in the insertion direction (right direction in FIG. 12) in which the fitting projection 26e is pulled out from the fitting hole 25e, the distance between the support 25 and a portion of the reflector 27 which moves toward the support 25 is denoted by B. If the distance B is shorter than the insertion amount A in the moving direction (insertion direction), the fitting projection 26e is less likely to be pulled out. In this case, the reflector 27 comes into contact with the support 25 before the fitting projection 26e is completely pulled out, thereby hindering the pulling out of the fitting projection 26e.

As described above, by setting the distance B to be smaller than the insertion amount A in the moving direction (insertion direction), the fitting projection 26e is less likely to be pulled out. This configuration can reduce the risk of the base 26 accidentally falling off from the support 25. By reducing the risk of the base 26 falling off from the support 25 in this manner, the base 26, the reflector 27, and the nip forming member 24 are all held as a single unit integrated with the support 25. This configuration can reduce the risk of any of the base 26, the reflector 27, and the nip forming member 24 falling off when the pressure between the fixing belt and the pressure roller is released. As a result, it is possible to suppress damage to the fixing belt due to falling of the base 26, the reflector 27, or the nip forming member 24. In addition, since all of the base 26, the reflector 27, and the nip forming member 24 can be handled as a single unit integrated with the support 25, it is possible to easily perform a process of mounting this unit into the fixing belt.

When the fitting projection 26e is pulled out, if multiple portions of the reflector 27 moves toward the support 25, at least one of the distances B in the moving direction (insertion direction) between these portions and the support 25 only has to be smaller than the insertion amount A of the fitting projection 26e. Moreover, if the distance B is shorter than the insertion amount A in the moving direction (insertion direction), when the unit formed of the base 26, the reflector 27, and the nip forming member 24 is attached to the support 25, the reflector 27 and the support 25 may interfere with each other. In such cases, however, the reflector 27 may be elastically deformed to temporarily increase the distance B in the moving direction (insertion direction), after which the attaching process may be performed.

A heating device includes a first rotator; and a second rotator facing an outer surface of the first rotator. The first rotator includes a nip forming member in contact with an inner face of the first rotator to form a nip portion between the first rotator and the second rotator; a heating source to heat the first rotator; a reflector elongated in a longitudinal direction, the reflector to reflect heat generated by the heating source to the inner face of the first rotator; a support to receive a pressure from the second rotator via the nip forming member; and a base interposed between the support and the nip forming member. The reflector includes a reflecting section facing the heating source; and a heat transmission section between the base and the nip forming member, and the heat transmission section includes a positioning section disposed at a vicinity of a center of the heat transmission section in the longitudinal direction, the positioning section positions the reflector with respect to the base, the positioning section having a first contacting area contacting with the nip forming member; and end sections closer to both ends of the heat transmission section than the positioning section in the longitudinal direction, each of the end sections having a second contacting area smaller than the first contacting area to contact with the nip forming member.

The positioning section is disposed at the center of the heat transmission section in the longitudinal direction. The end sections have holes or recesses, the holes or the recesses are arranged in the heat transmission section separately in a direction intersecting the longitudinal direction, the heat transmission section includes a heat transfer assist section disposed between the holes or between the recesses, and the heat transfer assist section contacts the nip forming member.

The reflector includes multiple heat transmission sections including the heat transmission section, and the multiple heat transmission sections are divided from one another and arrayed in the longitudinal direction. The base has engagement projections on an upstream end and a downstream end of the base in a conveyance direction intersecting the longitudinal direction, and the nip forming member has engagement holes engageable with the engagement projections of the base.

The end sections have holes or recesses, and the engagement projections of the base protrude toward the nip forming member through the holes of the end sections in the heat transmission section. The support has a fitting hole, and the base has a fitting projection insertable and fittable into the fitting hole in the support in an insertion direction, and the fitting projection is inserted and fitted into the fitting hole by an insertion amount in the insertion direction, and a distance between a portion of the support and a portion of the reflector facing each other in the insertion direction is shorter than the insertion amount when the fitting projection is fitted into the fitting hole.

A fixing device includes the heating device to heat a recording medium, on which an unfixed image is formed, to fix the unfixed image onto the recording medium. An image forming apparatus includes the heating device.

The heat transmission section includes a positioning section disposed at a vicinity of a center of the sheet in a width direction of the sheet passing through the nip portion and facing the heat transmission section, the positioning section positions the reflector with respect to the base, the positioning section having a first contacting area contacting with the nip forming member; and end sections closer to both ends of the sheet in the width direction than the positioning section in the longitudinal direction, each of the end sections having a second contacting area smaller than the first contacting area to contact with the nip forming member.

Although the embodiment of the present embodiment has been described above, the present embodiment can be applied to other heating devices in addition to fixing devices. For example, the present embodiment can also be applied to drying devices that dry liquid, such as ink, that has been applied to sheets, laminators that bond films as covering members onto surfaces of sheets, such as paper sheets, in a thermocompression bonding technique, and heating devices, such as heat sealers, that bonds sealing portions of packaging materials in a thermocompression bonding technique.

According to the present embodiment, it is possible to control a decrease in temperature at both ends of a rotator in a longitudinal direction thereof and to position a reflector.

To summarize the aspects of the present embodiment described above, the present embodiment contains at least the following Aspects.

### Aspect 1

According to Aspect 1, a heating device includes: a first rotator; a second rotator disposed so as to face an outer surface of the first rotator; a nip forming member that forms a nip portion in which the first rotator and the second rotator are in contact with each other with the first rotator between the nip forming member and the second rotator; a heating source disposed inside the first rotator; a reflector disposed inside the first rotator; a support that receives pressure of the second rotator via the nip forming member; and a base interposed between the support and the nip forming member. The reflector includes: a reflecting section that is disposed so as to face the heating source and reflects heat from the heating source to an inner face of the first rotator; and a heat transmission section that is pressurized between the base and the nip forming member. The heat transmission section includes: a hole or a recess provided so that an area of the heat transmission section in contact with the nip forming member is smaller at both ends of the heat transmission section than at a center of the heat transmission section in a longitudinal direction thereof; and a positioning section that is provided closer to a center of the heat transmission section than the hole or the recess in the longitudinal direction and through which the reflector is positioned with respect to the base.

### Aspect 2

According to Aspect 2, in the heating device of Aspect 1, the positioning section is disposed at the center of the heat transmission section in the longitudinal direction.

### Aspect 3

According to Aspect 3, in the heating device of Aspect 1 or 2, the hole or the recess includes multiple holes or recesses, the holes or the recesses are arranged in the heat transmission section separately in a direction intersecting the longitudinal direction, and the heat transmission section includes a heat transfer assist section disposed between the holes or between the recesses arranged separately in the direction intersecting the longitudinal direction so as to be in contact with the nip forming member.

### Aspect 4

According to Aspect 4, in the heating device of one of Aspects 1 to 3, the heat transmission section includes multiple heat transmission sections that are arranged in line in the longitudinal direction of the heat transmission section.

### Aspect 5

According to Aspect 5, in the heating device of one of Aspects 1 to 4, an upstream side and downstream side of the base in a sheet conveyance direction in which a sheet passes through the nip portion are provided with respective engagement projections, and the nip forming member has engagement holes with which the engagement projections engage.

### Aspect 6

According to Aspect 6, in the heating device of Aspect 5, the engagement projections are disposed so as to protrude toward the nip forming member through the hole in the heat transmission section.

### Aspect 7

According to Aspect 7, in the heating device of one of Aspects 1 to 6, the base includes a fitting projection that is inserted and fitted into a fitting hole in the support, and when the fitting projection moves in a direction in which the fitting projection is pulled out from the fitting hole, a distance in a moving direction between the support and a portion of the reflector which moves toward the support is shorter than an amount by which the fitting projection is inserted into the fitting hole.

### Aspect 8

According to Aspect 8, a fixing device uses the heating device of any one of Aspects 1 to 7 to heat a recording medium carrying an unfixed image and fix the unfixed image onto the recording medium.

### Aspect 9

According to Aspect 9, an image forming apparatus includes the heating device of any one of Aspects 1 to 7 or the fixing device of Aspect 8.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A heating device comprising:
a first rotator; and
a second rotator facing an outer surface of the first rotator,
wherein the first rotator includes:
a nip forming member in contact with an inner face of the first rotator to form a nip portion between the first rotator and the second rotator;
a heating source to heat the first rotator;
a reflector elongated in a longitudinal direction, the reflector to reflect heat generated by the heating source to the inner face of the first rotator;
a support to receive a pressure from the second rotator via the nip forming member; and
a base interposed between the support and the nip forming member, and
the reflector includes:
a reflecting section facing the heating source; and
a heat transmission section between the base and the nip forming member, and
the heat transmission section includes:
a positioning section disposed at a vicinity of a center of the heat transmission section in the longitudinal direction, the positioning section positions the reflector with respect to the base, the positioning section having a first contacting area contacting with the nip forming member; and
end sections closer to both ends of the heat transmission section than the positioning section in the longitudinal direction, each of the end sections having a second contacting area smaller than the first contacting area to contact with the nip forming member.

2. The heating device according to claim 1,
wherein the positioning section is disposed at the center of the heat transmission section in the longitudinal direction.

3. The heating device according to claim 1,
wherein the end sections have holes or recesses,
the holes or the recesses are arranged in the heat transmission section separately in a direction intersecting the longitudinal direction,
the heat transmission section includes a heat transfer assist section disposed between the holes or between the recesses, and
the heat transfer assist section contacts the nip forming member.

4. The heating device according to claim 1,
wherein the reflector includes multiple heat transmission sections including the heat transmission section, and
the multiple heat transmission sections are divided from one another and arrayed in the longitudinal direction.

5. The heating device according to claim 1,
wherein the base has engagement projections on an upstream end and a downstream end of the base in a conveyance direction intersecting the longitudinal direction, and
the nip forming member has engagement holes engageable with the engagement projections of the base.

6. The heating device according to claim 5,
wherein the end sections have holes or recesses, and
the engagement projections of the base protrude toward the nip forming member through the holes of the end sections in the heat transmission section.

7. The heating device according to claim 1,
wherein the support has a fitting hole, and
the base has a fitting projection insertable and fittable into the fitting hole in the support in an insertion direction,
the fitting projection is inserted and fitted into the fitting hole by an insertion amount in the insertion direction, and
a distance between a portion of the support and a portion of the reflector facing each other in the insertion direction is shorter than the insertion amount when the fitting projection is fitted into the fitting hole.

8. A fixing device comprising:
the heating device according to claim 1 to heat a recording medium, on which an unfixed image is formed, to fix the unfixed image onto the recording medium.

9. An image forming apparatus comprising the heating device according to claim 1.

10. A heating device comprising:
a first rotator; and
a second rotator facing an outer surface of the first rotator,
wherein the first rotator includes:
a nip forming member in contact with an inner face of the first rotator to form a nip portion, between the first rotator and the second rotator;
a heating source to heat the first rotator;
a reflector elongated in a longitudinal direction, the reflector to reflect heat generated by the heating source to the inner face of the first rotator;
a support to receive a pressure from the second rotator via the nip forming member; and
a base interposed between the support and the nip forming member, and
the reflector includes:
a reflecting section facing the heating source; and
a heat transmission section between the base and the nip forming member, and
the heat transmission section includes:
a positioning section disposed at a vicinity of a center of the sheet in a width direction of the sheet passing through the nip portion and facing the heat transmission section, the positioning section positions the reflector with respect to the base, the positioning section having a first contacting area contacting with the nip forming member; and
end sections closer to both ends of the sheet in the width direction than the positioning section in the longitudinal direction, each of the end sections having a second contacting area smaller than the first contacting area to contact with the nip forming member.

11. A fixing device comprising:
the heating device according to claim 10 to heat a recording medium, on which an unfixed image is formed, to fix the unfixed image onto the recording medium.

12. An image forming apparatus comprising the heating device according to claim 10.
